(19) United States
(12) Patent Application Publication
(10) Pub. No.: US 2017/0325254 A1
(43) Pub. Date: Nov. 9, 2017

(54) DEFAULT SPATIAL REUSE MODES

(71) Applicant: QUALCOMM Incorporated, San Diego, CA (US)

(72) Inventors: Yan ZHOU, San Diego, CA (US); Gwendolyn Denise BARRIAC, Encinitas, CA (US); George CHERIAN, San Diego, CA (US); Simone MERLIN, San Diego, CA (US); Alfred ASTERJADHI, San Diego, CA (US)

(21) Appl. No.: 15/584,495

(22) Filed: May 2, 2017

Related U.S. Application Data
(60) Provisional application No. 62/333,138, filed on May 6, 2016.

(51) Int. Cl. H04W 72/12; H04B 7/26; H04L 1/00; H04L 27/00; H04J 11/00; H04L 5/00; H04L 1/18; H04W 74/00; H04W 84/04; H04W 84/12; H04L 12/28

(52) U.S. Cl. CPC H04W 72/1252; H04J 11/005; H04B 7/2656; H04L 1/0026; H04L 27/0008; H04L 27/00; H04L 5/0073; H04L 5/00; H04L 1/1819; H04L 1/00; H04W 74/004; H04W 74/006; H04W 84/04; H04W 84/12; H04L 12/28

(57) ABSTRACT

Certain aspects of the present disclosure relate to specifying possible default spatial reuse (SR) modes and signaling of the default spatial reuse modes. Certain aspects of the present disclosure provide a method for wireless communications. The method generally includes generating a frame that provides an indication, to a secondary recipient of the frame, of how to use spatial reuse (SR) information and transmitting the frame. Another provided method for wireless communications generally includes receiving, from a first node, a first frame that provides an indication of how to use spatial reuse (SR) information, determining if a signal strength of the first frame exceeds a threshold, generating a second frame for transmission to a second node, and if the signal strength of the first frame does not exceed the threshold, transmitting the second frame during a period when the first frame is being transmitted.

### CROSS-REFERENCE TO RELATED APPLICATIONS

The present application for patent claims priority to U.S. Provisional Application No. 62/333,138, filed May 6, 2016, which is assigned to the assignee of the present application and hereby expressly incorporated by reference herein in its entirety.

### BACKGROUND

### Field of the Disclosure

Certain aspects of the present disclosure generally relate to wireless communications and, more particularly, to specifying possible default spatial reuse (SR) modes and signaling of the default spatial reuse modes.

### Description of Related Art

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique for communication systems. MIMO technology has been adopted in several wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (e.g., tens of meters to a few hundred meters).

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Certain aspects of the present disclosure provide a method for wireless communication. The method generally includes generating a frame that provides an indication, to a secondary recipient of the frame, of how to use spatial reuse (SR) information and transmitting the frame.

Certain aspects of the present disclosure provide another method for wireless communication that may be performed by a first node. The method generally includes receiving, from a second node, a portion of a first frame that provides an indication of how to use spatial reuse (SR) information, determining if a signal strength of the first frame equals or exceeds a threshold, and if the signal strength of the first frame does not equal or exceed the threshold, transmitting a second frame to a third node during a period when the first frame is being transmitted.

Certain aspects of the present disclosure provide an apparatus for wireless communications. The apparatus generally includes at least one processor configured to generate a frame that provides an indication, to a secondary recipient of the frame, of how to use spatial reuse (SR) information, and to transmit the frame; and a memory coupled with the at least one processor.

Certain aspects of the present disclosure provide an apparatus for wireless communications. The apparatus generally includes at least one processor configured to receive, from a first node, a portion of a first frame that provides an indication of how to use spatial reuse (SR) information, to determine if a signal strength of the first frame equals or exceeds a threshold, and, if the signal strength of the first frame does not equal or exceed the threshold, to transmit a second frame to a third node during a period when the first frame is being transmitted and a memory coupled with the at least one processor.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates an example wireless communications network, in accordance with certain aspects of the present disclosure.

FIG. 2 is a block diagram of an example access point (AP) and user terminals, in accordance with certain aspects of the present disclosure.

FIG. 3 is a block diagram of an example wireless device, in accordance with certain aspects of the present disclosure.

FIG. 4 illustrates an exemplary wireless communications network in which aspects of the present disclosure may be practiced.

FIG. 5 illustrates example fields of a frame preamble, in accordance with certain aspects of the present disclosure.

FIG. 6 illustrates example operations for wireless communications that a STA may perform, in accordance with certain aspects of the present disclosure.

FIG. 7 illustrates example operations for wireless communications that a node may perform, in accordance with certain aspects of the present disclosure.

FIG. 8 illustrates an exemplary relationship between a received power level of a first frame and a transmit power level, in accordance with certain aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects of the present disclosure generally relate to specifying possible default spatial reuse (SR) modes and signaling of the default SR modes. As will be described in more detail herein, a station (STA) that sends an overlapping basic service set (OBSS) frame may determine that the STA prefers that other STAs perform SR over the OBSS frame according to a default SR mode instead of performing SR based on a clear channel assessment (CCA) level or interference level indicated in an SR information field in the OBSS frame.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the AT may be a wireless node. Such wireless node may provide, for example, connectivity for or to a network (e.g., a wide area network such as the Internet or a cellular network) via a wired or wireless communication link.

### An Example Wireless Communication System

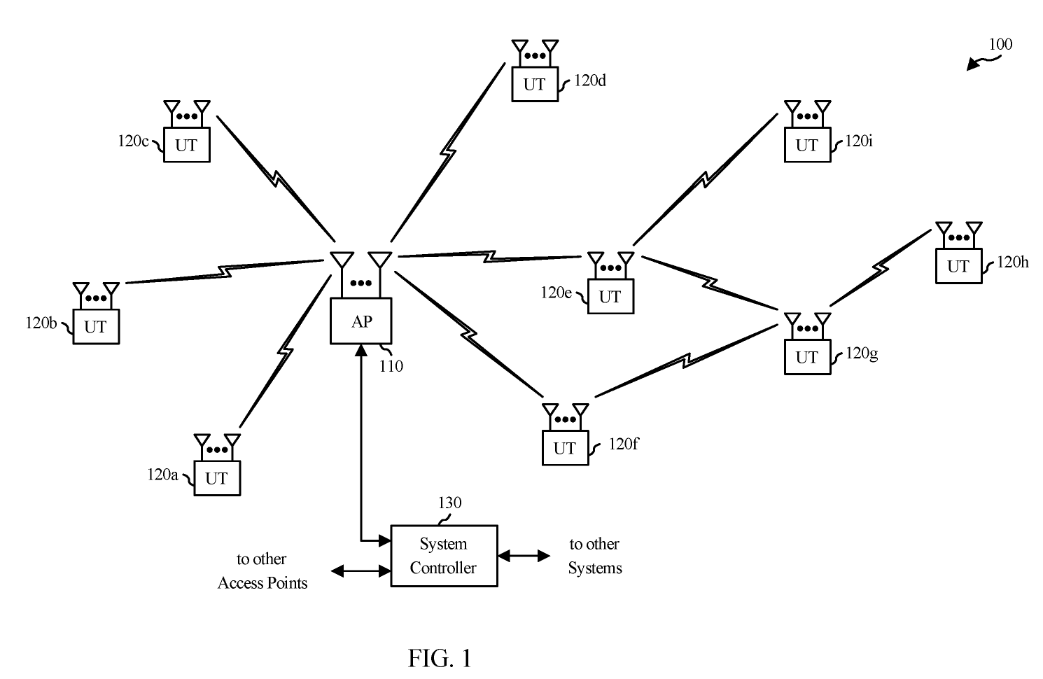

FIG. 1 illustrates a system 100 in which aspects of the disclosure may be performed. For example, the user terminal 120e may send an OBSS frame (e.g., a physical layer convergence protocol (PLCP) protocol data unit (PPDU)) to AP 110 having an indication that other STAs should perform SR according to a default mode instead of performing SR according to a CCA level or interference level included in an SR information field of the OBSS frame. Recipient user terminals 120 (e.g., UT 120g) may determine, based on the indication, to perform SR according to the indicated default mode and may begin generating and transmitting a frame to other recipients (e.g., UT 120h) before the UT 120e completes transmitting of the OBSS frame.

The system 100 may be, for example, a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

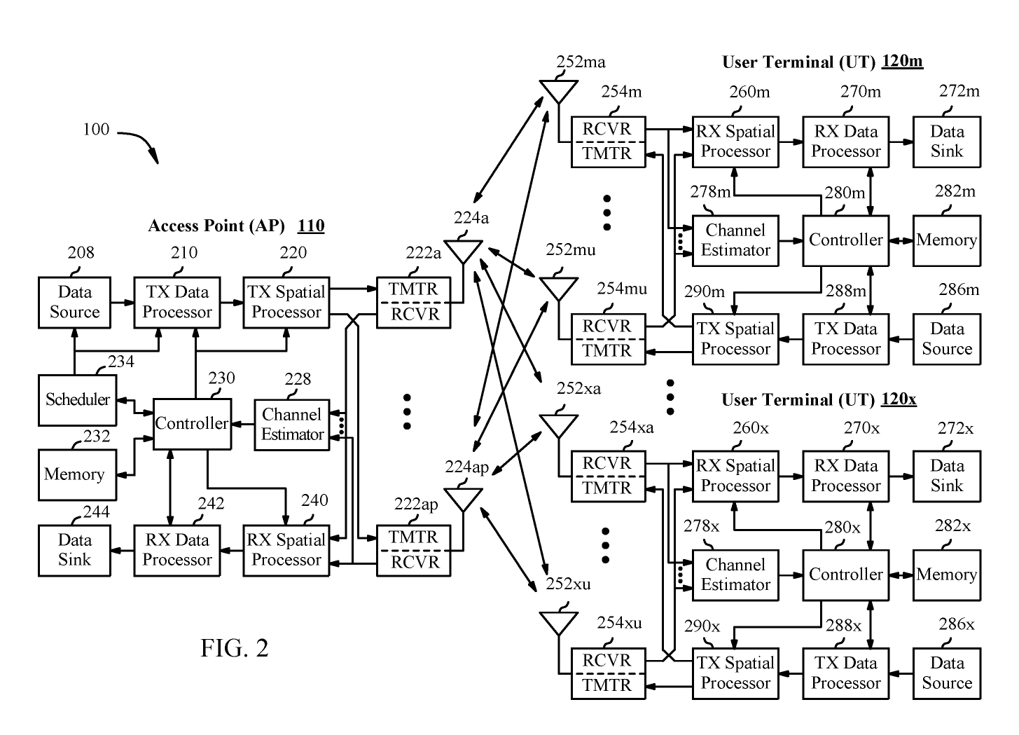

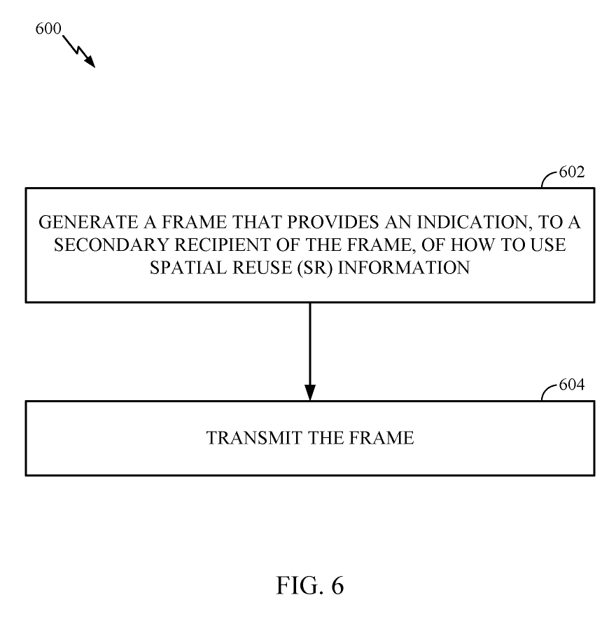

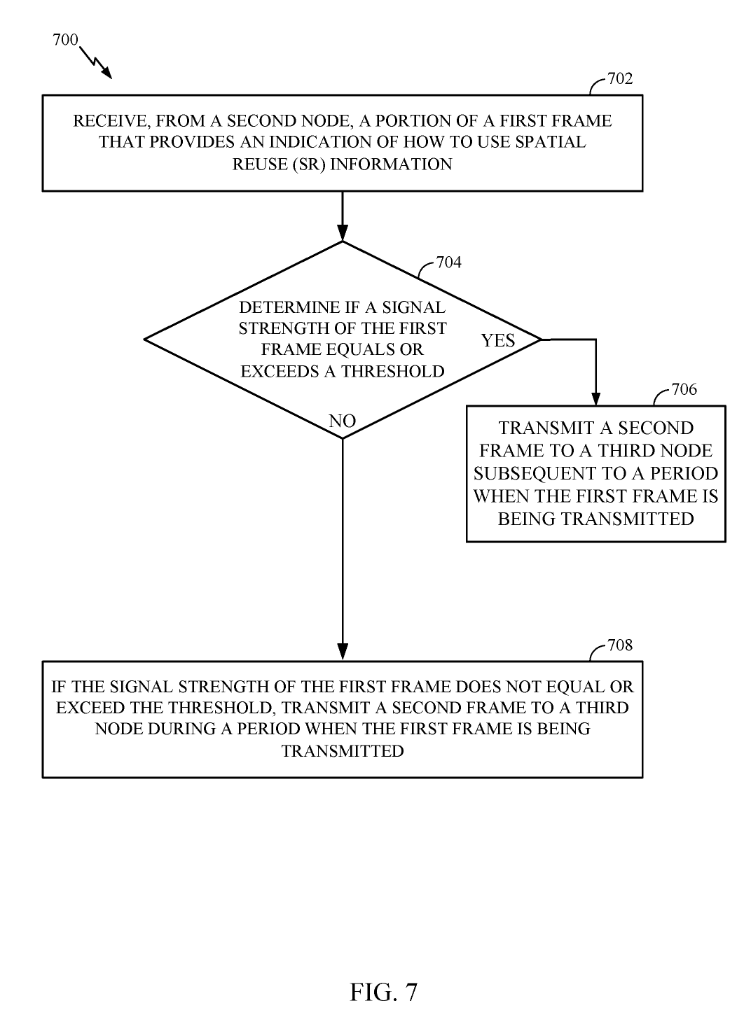

FIG. 2 illustrates example components of the AP 110 and UT 120 illustrated in FIG. 1, which may be used to implement aspects of the present disclosure. One or more components of the AP 110 and UT 120 may be used to practice aspects of the present disclosure. For example, antenna 224, Tx/Rx 222, processors 210, 220, 240, 242, and/or controller 230 may be used to perform the operations described herein and illustrated with reference to FIGS. 6 and 6A. Similarly, antenna 252, Tx/Rx 254, processors 260, 270, 288, and 290, and/or controller 280 may be used to perform the operations described herein and illustrated with reference to FIGS. 7 and 7A.

FIG. 2 illustrates a block diagram of access point 110 two user terminals 120m and 120x in a MIMO system 100. The access point 110 is equipped with Nₜ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals. The decoded data for each user terminal may be provided to a data sink 272 for storage and/or a controller 280 for further processing.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

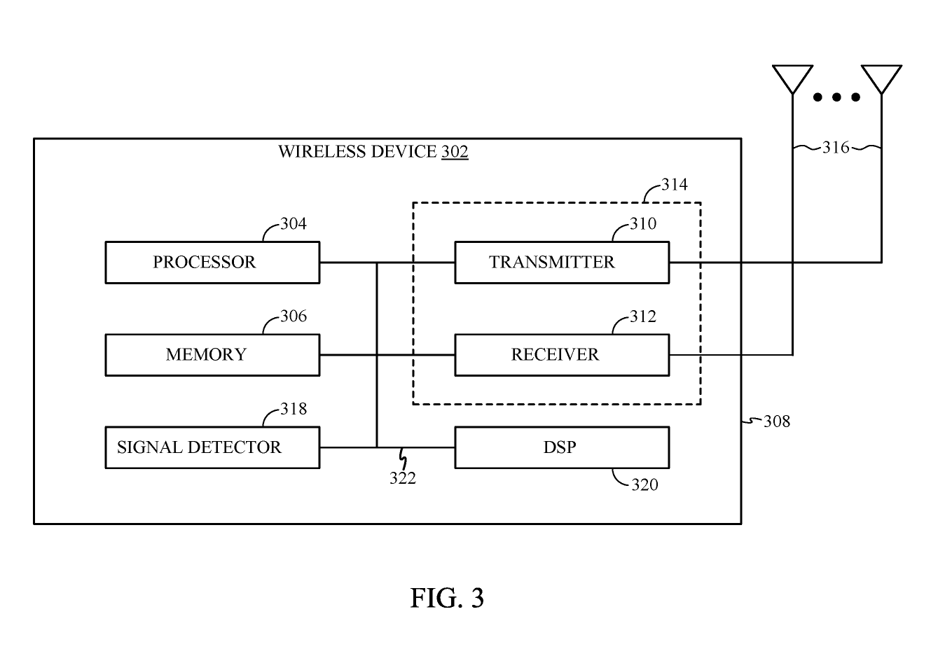

FIG. 3 illustrates various components that may be utilized in a wireless device 302 that may be employed within the MIMO system 100. The wireless device 302 is an example of a device that may be configured to implement the various methods described herein. For example, the wireless device may implement operations 1000 and 1100 illustrated in FIGS. 10 and 11, respectively. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Default Spatial Reuse Modes

Spatial reuse (SR) in IEEE 802.11 wireless communications refers to a station (STA) transmitting on a channel despite detecting that another STA is already transmitting on that channel. The STA may receive a portion of a frame, determine that the STA is allowed to transmit while the frame is being transmitted, and begin transmitting another frame.

According to aspects of the present disclosure, a STA may begin receiving an overlapping basic service set (OBSS) packet layer convergence protocol (PLCP) protocol data unit (PDU) (e.g., a frame) for which the STA is an unintended or secondary recipient, the STA may determine that the OBSS PLCP PDU (PPDU) indicates that the STA may transmit on the channel while the OBSS PPDU is still being transmitted, and the STA may begin transmitting (e.g., another PPDU) on the channel before transmission of the OBSS PPDU is complete. By beginning transmission on the channel before transmission of the OBSS PPDU is complete, the STA may improve throughput and latency of communications by the STA with other nodes, because the STA does not wait for completion of a communication that is not intended for the STA (i.e., the OBSS PPDU) before starting the transmission. That is, the STA may transmit on radio frequency resources simultaneously with the transmission of the OBSS PPDU, thus improving utilization of radio frequency resources in an area without causing so much interference that an intended recipient of the OBSS PPDU is unable to receive the OBSS PPDU. A STA operating according to the IEEE 802.11ax standard may regard a valid OBSS PPDU as not having been received at all (e.g., the STA does not consider the channel busy), except for the time required by the STA to validate that the OBSS PPDU is from a basic service set (BSS) other than the BSS to which the STA belongs (i.e., the OBSS PPDU is an Inter-BSS PPDU), if the received power (RXPWR) of the OBSS PPDU is below an OBSS packet detection (OBSS_PD) threshold and other conditions are met.

As used herein, an “intended recipient” or “primary recipient” of a PPDU (i.e., a packet) is a node to which the transmitter of the PPDU intends to convey at least some of the payload (e.g., data) of the PPDU. Thus, as used herein, “intended recipient” and “primary recipient” are synonymous and are used interchangeably.

Also as used herein, an “unintended recipient” or “secondary recipient” of a PPDU is a node to which the transmitter does not intend to convey any of the payload of the PPDU. Thus, as used herein, “unintended recipient” and “secondary recipient” are synonymous and are used interchangeably. For example, a transmitter of a PPDU may include a data payload in the PPDU for an intended or primary recipient to obtain from the PPDU, and the transmitter may also include some control information in the PPDU (e.g., in a header of the PPDU) that is intended for both primary (i.e., intended) and secondary (i.e., unintended) recipients to receive, such as a MAC address of an intended recipient (e.g., so that each recipient can determine if the PPDU is intended for that recipient) and information regarding whether a secondary (i.e., unintended) recipient of the PPDU can perform spatial reuse of frequency resources used to transmit the PPDU during a period when the PPDU is being transmitted. In the example, the PPDU may be an OBSS PPDU with regard to a secondary recipient, if the transmitter and intended recipient are both members of a first BSS and the secondary recipient if a member of a second, different BSS.

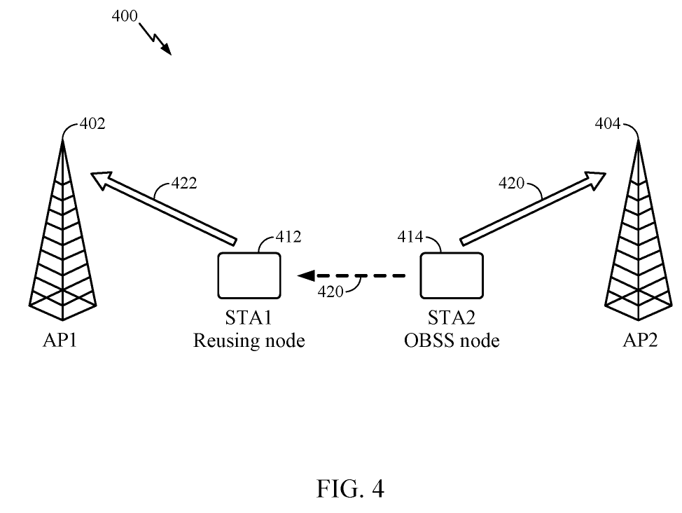

FIG. 4 illustrates an exemplary wireless communications network 400 in which aspects of the present disclosure may be practiced. The exemplary wireless communications network includes a first AP 402, a first STA 412, a second STA 414, and a second AP 404. The first AP and first STA are members of a first BSS, and the second AP and second STA are members of a second BSS. Thus, in the exemplary wireless communications network, the second STA is an OBSS node with regard to the first STA. At a time, T, the second STA may begin transmitting a PPDU 420 to the second AP. The first STA also may begin receiving the PPDU at the time, T. The PPDU may be treated as an OBSS PPDU by the first STA, because the PPDU originates in a BSS other than the BSS of the first STA and because the intended recipient of the PPDU (the second AP) is also in a BSS other than the BSS of the first STA. Shortly after time T, the first STA determines (e.g., based on one or more fields of a header of the PPDU) that the PPDU is not intended for the first STA and that the PPDU indicates that stations receiving may perform spatial reuse over the PPDU. The first STA may then begin performing spatial reuse by transmitting a PPDU 422 to the first AP while the second STA is still transmitting the PPDU 420.

When receiving an OBSS frame (e.g., an OBSS PPDU), a STA may decide whether to perform SR by checking SR information that may be included in the OBSS frame. The SR information may comprise, for example, indications of a CCA level or an interference level selected by a node that transmitted the OBSS frame. If an interference level is indicated, then the STA may perform spatial reuse over the OBSS frame, if interference to an OBSS link (e.g., a link between the transmitter and an intended recipient of the OBSS frame) caused by the spatial reuse transmission is below the indicated interference level. If a CCA level is indicated in the SR information, then the STA may perform spatial reuse over the OBSS frame if the OBSS frame's reference signal strength indicator (RSSI), as measured by the STA, is below the indicated CCA level. In aspects of the present disclosure, SR information may also include other variants, which are still based on caused interference or measured RSSI. More generally, a STA may obtain (e.g., receive) a frame (e.g., an OBSS frame), determine an indication of a CCA level and/or an interference level from the frame, and determine whether to perform SR over the frame based on the indication(s) and at least one of interference potentially caused by the STA performing SR and/or an RSSI of the frame.

SR information may include SR parameters that may be carried in an SR field of a signal (SIG) field (e.g., a SIG-A field) in a frame preamble. Because it is desirable for frame preamble lengths to be fixed (e.g., to enable stations to properly interpret frame preambles), it may be desirable for a format of an SR field to be fixed, to prevent dynamic changes to preamble lengths in a network.

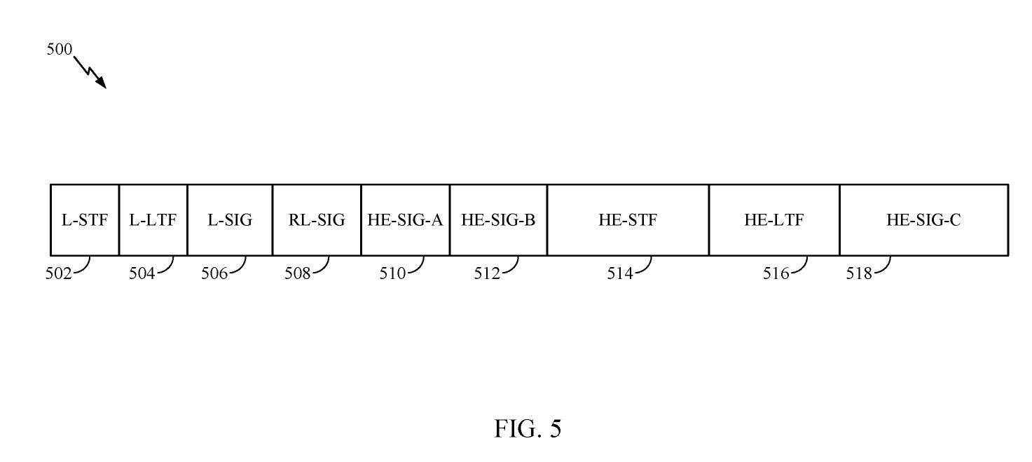

FIG. 5 illustrates example fields of a frame preamble (e.g., a PHY header) 500 that may be included in an OBSS frame that may carry SR information (e.g., in an SR field), in accordance with certain aspects of the present disclosure. According to aspects of the present disclosure, a preamble of an OBSS frame may include a legacy short training field (L-STF) 502, a legacy long training field (L-LTF) 504, a legacy signal field (L-SIG) 506, a repeated L-SIG field (RL-SIG) 508, a high efficiency signal field A (HE-SIG-A) 510, a high efficiency signal field B (HE-SIG-B) 512, a high efficiency short training field (HE-STF) 514, a high efficiency long training field (HE-LTF) 516, and a high efficiency signal field C (HE-SIG-C) 518. SR information may be carried in one of the signal fields, e.g., the L-SIG field, the RL-SIG field, the HE-SIG-A field, the HE-SIG-B field, and/or the HE-SIG-C field. As an example, the HE-SIG-A field 510 may carry SR information in an SR field of the HE-SIG-A field.

According to aspects of the present disclosure, an OBSS frame sender (e.g., a device transmitting the OBSS frame) may sometimes prefer that another STA (e.g., a node) use a default SR mode instead of performing SR according to a CCA level or an interference level included in SR information. If an OBSS frame sender prefers that other STAs should use a default SR mode instead of performing SR according to a CCA level or an interference level included in SR information, then the OBSS frame sender may indicate that preference in the OBSS frame.

FIG. 6 illustrates example operations 600 that a STA (e.g., STA 120e shown in FIG. 1, STA 414 shown in FIG. 4) may perform to indicate that a recipient of a frame (e.g., an OBSS frame) should perform SR over the frame according to a default SR mode instead of performing SR according to a CCA level or an interference level included in SR information, according to aspects of the present disclosure.

Operations 600 begin at block 602 with the STA generating a frame that provides an indication, to a secondary recipient of the frame, of how to use spatial reuse (SR) information. In some instances, the indication of how to use SR information may include an indication of whether or not to use SR information. For example, STA 414 (shown in FIG. 4), may generate a frame 420 for transmission to AP 404 that includes a particular value in an SR field of the frame that indicates an unintended recipient of the frame, such as STA 412, should not use SR information and should instead perform SR over the frame according to a default rule.

At block 604, the STA transmits the frame. Continuing the example, the STA 414 transmits the frame 420 to AP 404.

FIG. 7 illustrates example operations 700 that a first node (e.g., STA 120g shown in FIG. 1, STA 412 shown in FIG. 4) may execute to perform SR according to an indication in a frame, according to aspects of the present disclosure. Operations 700 may be considered complementary to Operations 600, shown in FIG. 6.

Operations 700 begin at block 702 with the first node receiving, from a second node, a portion of a first frame that provides an indication of how to use spatial reuse (SR) information. For example, STA 412 (shown in FIG. 4) may receive, from STA 414, a frame 420 that provides an indication (e.g., in a header of the frame) to not use SR information and instead perform SR over the frame according to a default rule. In the example, if the frame is transmitted by and intended for nodes that are in a BSS to which the STA 412 does not belong, the frame 420 may be considered an OBSS PPDU by the STA 412.

At block 704, the first node determines if a signal strength of the first frame equals or exceeds a threshold. If the signal strength of the first frame equals or exceeds the threshold, then Operations 700 may continue at block 706. If the signal strength of the first frame does not equal or exceed the threshold, then Operations 700 may continue at block 708. Continuing the example from above, the STA 412 may determine that the signal strength of the frame 420 does not exceed a threshold (e.g., OBSS_PD), where the threshold may, for example, be determined according to the default rule. In the example, the STA 412 may continue to block 708.

At block 706, the first node transmits a second frame to a third node subsequent to a period when the first frame is being transmitted. In the example from above, the STA 412 may transmit a frame 422 to a third node, such as AP 402, subsequent to a period when the frame 420 is being transmitted.

At block 708, if the signal strength of the first frame does not equal or exceed the threshold, the first node transmits the second frame to a third node during a period when the first frame is being transmitted. The first node may transmit the second frame even though transmission of the first frame is not complete, because the signal strength of the first frame being less than the threshold indicates that transmitting the second frame by the first node will not interfere with reception of the first frame by an intended recipient of the first frame. Continuing the example from above, the STA 412 transmits the frame 422 to a third node, such as AP 402, because, as the STA 412 determined in block 704, the signal strength of the frame 420 does not exceed the threshold.

According to aspects of the present disclosure, default spatial reuse modes to use when a frame sender does not desire unintended recipients to use SR information, which may be included in the frame, may include: 1) a no spatial reuse mode; 2) a spatial reuse mode that includes treating the frame as a pre-IEEE 802.11ax legacy frame according to the IEEE 802.11ac or other legacy standard; and/or 3) a spatial reuse mode that includes selecting a CCA level to use in deciding whether to perform spatial reuse, where the decision is to perform spatial reuse if RSSI of the frame is below the CCA level, and selecting a transmit power corresponding to the CCA level if reuse is decided, where the transmit power is selected based on a default rule, which is not specified by the frame.

According to aspects of the present disclosure, an OBSS frame sender may prefer that other STAs not perform SR during the duration of the OBSS frame. For example, the OBSS frame sender may prefer that other STAs not perform SR during the duration of the OBSS frame because the OBSS frame sender is not able to determine SR levels, possibly due to implementation limitations of the OBSS frame sender or lack of sufficient information, e.g., regarding path loss to an intended recipient. In the example, the OBSS frame sender node may have a simple implementation that causes the OBSS frame sender to not perform SR level computation and the corresponding information collection. Additionally or alternatively, the OBSS frame sender may not have any information about an intended recipient on which to base computation of an SR level, for example, if the OBSS frame sender is sending to a node that has not previously communicated with the OBSS frame sender.

According to aspects of the present disclosure, an OBSS frame sender may prefer that other STAs perform SR during the duration of the OBSS frame by treating the OBSS frame as an IEEE 802.11ac frame (e.g., by performing SR if a power level of the OBSS frame allows SR according to the IEEE 802.11 ac standard). Treating the OBSS frame as an IEEE 802.11ac frame may cause the unintended recipient to not perform SR, or to perform SR by selecting a CCA level to decide reuse and a transmit power, for transmitting a frame while performing SR, corresponding to the CCA level and based on a default rule, if reuse is decided. More generally, a frame sender may include an indication of whether an unintended recipient should perform SR over the frame while following a first set of one or more rules (e.g., treating the frame as an IEEE 802.11ax frame) or while following a second set of one or more rules (e.g., treating the frame as a pre-IEEE 802.11ax frame).

According to aspects of the present disclosure, an OBSS frame sender may prefer that another STA perform SR during the duration of the OBSS frame by selecting a CCA level to use in deciding whether to perform spatial reuse and a transmit power (e.g., for the potential transmission if the decision is to perform spatial reuse) corresponding to the CCA level based on a default rule, if reuse is decided by the other STA. For example, an unintended recipient of a first frame (e.g., an OBSS frame) may decide to reuse over the first frame if RSSI of the first frame is below a selected CCA level and, if reuse is decided, the unintended recipient may further decide a transmit power corresponding to the CCA level based on a default mapping, which may be determined based on indications from an associated access point of the unintended recipient and/or based on one or more wireless communications standards (e.g., IEEE 802.11ax).

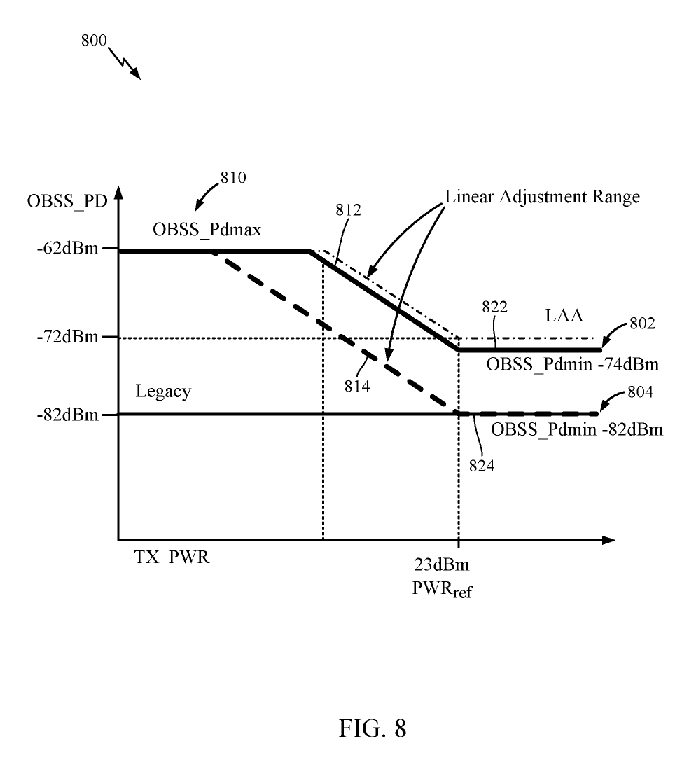

FIG. 8 is a graph 800 illustrating exemplary OBSS threshold (OBSS_PD) level and transmit power (TX_PWR) curves 802, 804. As illustrated, each curve may start at a maximum OBSS packet detection threshold level (OBSS_PDmax) corresponding to low transmit power levels, as at 810. Curve 802 includes a linear adjustment range 812, and curve 804 includes another linear adjustment range 814. Curve 802 includes a range 822 at a minimum OBSS packet detection threshold level (OBSS_PDmin), and curve 804 includes another range 824 at another minimum OBSS threshold level. One of the OBSS_PD level and TX_PWR curves may be used by a STA to select an operation point to use when determining whether to perform SR and, if the determination is to perform SR, to determine a transmit power level for transmitting a frame, according to aspects of the present disclosure. As an example, an unintended recipient (e.g., STA 412 shown in FIG. 4) of a first frame (e.g., an OBSS frame) may determine an operation point on the exemplary OBSS_PD level and TXPWR curve 804. In the example, the unintended recipient may, for example, determine a desirable transmit power to use in transmitting a frame to AP 402 and then determine an operation point on the curve 804 based on the desired transmit power. Continuing the example, the unintended recipient determines an OBSS_PD level based on the determined operation point and then determines if an RSSI of the first frame is less than the determined OBSS_PD level. Still in the example, if the RSSI of the first frame is less than the determined OBSS_PD level, the STA determines to perform SR over the first frame and determines a transmit power, to use in transmitting a second frame, based on the determined operation point (e.g., less than or equal to the desirable transmit power used in determining the operation point).

According to aspects of the present disclosure, default SR mode(s), to be used when a frame sender does not desire an unintended recipient of the frame to use SR information (which may be included in the frame), can be signaled by using reserved SR level(s) in one or more subfields of the frame, by using a dedicated indicator in an SR field of the frame, and/or by using a dedicated indicator in the frame that is not in an SR field of the frame. That is, a frame sender can signal a default SR mode to be used by other STAs by using reserved SR level(s) in subfield(s) of the frame (e.g., setting a field or subfield of the frame to the reserved value), by using a dedicated indicator in an SR field of the frame, and/or by using a dedicated indicator in other (non-SR) field(s) of the frame.

According to aspects of the present disclosure, values of SR levels may be reserved (e.g., in a network standard, such as an IEEE 802.11ax standard) to signal certain default spatial reuse modes that differ from the original use of SR levels in a frame, and a frame sender may set an SR field of the frame to a reserved value to signal an SR mode to an unintended recipient of the frame. For example, a first reserved value may indicate that no SR is allowed, a second reserved value may indicate that an unintended recipient may perform SR while treating the frame as an IEEE 802.11ac frame, and a third reserved value may indicate an unintended recipient should perform SR according to a default mode of the unintended recipient (e.g., selecting an operating point along an OBSS_PD and TXPWR curve, determining if RSSI of the frame is less than the OBSS_PD level of the operating point, and, if the RSSI is less than the OBSS_PD level, transmitting a frame using the TXPWR level of the operating point).

According to aspects of the present disclosure, a frame (e.g., an OBSS frame) sender may use reserved CCA level(s) and/or reserved interference level(s) in subfields of an SR field of the frame to signal a default SR mode(s) to be used by unintended recipients of the frame. For example, CCA and interference levels may be signaled in separate subfields in an SR field of a frame. In the example, an SR field may include 3 bits for signaling 7 CCA levels and 5 bits for signaling 20 interference levels. Still in the example, one unused bit sequence in each subfield may be defined as a reserved level, and combinations of different reserved levels in both subfields may be used to signal default SR mode(s) to be used by unintended recipients of the frame. Still in the example, a frame sender may set the three bits of a CCA subfield of the SR field to a reserved value to signal to an unintended recipient of the frame to not perform SR over the frame.

According to aspects of the present disclosure, an unintended recipient may determine a frame includes at least one reserved value in at least one of a CCA level subfield or an interference level subfield and determine an SR mode to use based on the reserved value. Continuing the example above, an unintended recipient may determine a frame includes a reserved value in three bits of a CCA subfield of an SR field in the frame and determine, based on the value of the CCA subfield, not to perform SR over the frame.

According to aspects of the present disclosure, a frame (e.g., an OBSS frame) sender may use reserved CCA level(s) and reserved interference level(s) in an SR field of the frame to signal a default SR mode(s) to be used by unintended recipients of the frame. For example, CCA and interference levels may be encoded in a same subfield in an SR field, and the SR field may be 5 bits to signal 7 CCA levels or 20 interference levels. In the example, one or more unused bit sequences in the same subfield of the SR field can be defined as a reserved level(s) and used to signal default SR mode(s) to be used by unintended recipients of the frame. Still in the example, a frame sender may set the SR field to a reserved value to indicate that an unintended recipient should treat the frame as an IEEE 802.11ac frame when performing SR over the frame.

According to aspects of the present disclosure, an unintended recipient may determine a frame includes a reserved value in an SR level field and determine an SR mode to use based on the reserved value. Continuing the above example, an unintended recipient may receive a frame including a reserved value in an SR field and determine, based on the reserved value, to treat the frame as an IEEE 802.11ac frame when determining whether and how to perform SR over the frame.

According to aspects of the present disclosure, an unintended recipient may determine a frame includes a reserved value in an SR level field and determine to use a default SR mode of the unintended recipient, based on the SR level field including the reserved value. The default SR mode may include selecting a CCA level, determining whether to perform spatial reuse if RSSI of the frame is below the selected CCA level, and selecting a corresponding transmit power (e.g., based on one of the exemplary curve 802 shown in FIG. 8) if the determination is to perform spatial reuse, where the transmit power corresponding to the selected CCA level is selected based on a default rule, which is not specified by the frame.

According to aspects of the present disclosure, a frame sender may set a flag in a frame (e.g., an OBSS frame) indicating whether the frame includes an SR field. In some aspects of the present disclosure, a lack of an SR field may indicate to an unintended recipient that the unintended recipient should perform SR using a default SR mode. For example, a frame sender may set a bit in a SIG-A of the frame to indicate there is no SR field in the frame and not include an SR field in the frame to indicate to an unintended recipient to perform SR by treating the frame as an IEEE 802.11ac frame. In the example, an unintended recipient of the frame may begin receiving the frame, read the bit in the SIG-A indicating there is no SR field in the frame, and the unintended recipient may then determine to treat the frame as an IEEE 802.11ac frame when performing SR over the frame.

According to aspects of the present disclosure, having a bit of a frame indicate whether the frame includes an SR field may cause presence of an SR field in a SIG-A field to be dynamically determined, which may cause length of the SIG-A field and of a preamble of the frame to be dynamically determined, such that not all frames used in the wireless network have preambles of the same length.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface to output a frame for transmission. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The various operations of methods described above may be performed by any suitable means capable of performing the corresponding functions. The means may include various hardware and/or software component(s) and/or module(s), including, but not limited to a circuit, an application specific integrated circuit (ASIC), or processor.

For example, means for receiving may be a receiver (e.g., the receiver unit of transceiver 254) and/or an antenna(s) 252 of the user terminal 120 illustrated in FIG. 2 or the receiver (e.g., the receiver unit of transceiver 222) and/or antenna(s) 224 of access point 110 illustrated in FIG. 2. Means for transmitting may be a transmitter (e.g., the transmitter unit of transceiver 254) and/or an antenna(s) 252 of the user terminal 120 illustrated in FIG. 2 or the transmitter (e.g., the transmitter unit of transceiver 222) and/or antenna(s) 224 of access point 110 illustrated in FIG. 2.

Means for processing, means for generating, means for obtaining, means for including, means for determining, and means for outputting may comprise a processing system, which may include one or more processors, such as the RX data processor 270, the TX data processor 288, and/or the controller 280 of the user terminal 120 illustrated in FIG. 2 or the TX data processor 210, RX data processor 242, and/or the controller 230 of the access point 110 illustrated in FIG. 2.

According to certain aspects, such means may be implemented by processing systems configured to perform the corresponding functions by implementing various algorithms (e.g., in hardware or by executing software instructions) described above for signaling at least one of whether and how to use SR information.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications performed by a node, comprising:
generating a frame that provides an indication, to a secondary recipient of the frame, of how to use spatial reuse (SR) information; and
transmitting the frame.

2. The method of claim 1, wherein the node and an intended recipient of the frame are members of an overlapping basic service set (OBSS) of the secondary recipient.

3. The method of claim 1, wherein the indication is provided via an SR field of a signal (SIG) portion of a preamble of the frame.

4. The method of claim 1, wherein the SR information is included in the frame.

5. The method of claim 1, wherein the indication indicates the secondary recipient should not perform SR.

6. The method of claim 1, wherein the indication indicates whether the secondary recipient should perform SR, based on the SR information, according to a first set of one or more rules or according to a second set of one or more rules.

7. The method of claim 6, wherein the first set includes SR rules when the frame is an 802.11ax frame, and the second set includes SR rules when the frame is a pre-802.11ax frame.

8. The method of claim 1, wherein the indication indicates that the secondary recipient should perform SR using a default mode.

9. The method of claim 8, wherein the default mode includes the secondary recipient selecting a CCA level and a transmit power for potential spatial reuse over the frame based on a default rule, which is not specified by the frame.

10. The method of claim 1, wherein:
the frame comprises an SR field having a clear channel assessment (CCA) level subfield and an interference level subfield; and
the method further comprises:
setting at least one of the CCA level subfield or the interference level subfield to a reserved value; and
selecting the reserved value based on how the secondary recipient should perform SR.

11. The method of claim 1, wherein:
the frame comprises an SR level field; and
the method further comprises:
setting the SR level field to a reserved value; and
selecting the reserved value based on how the secondary recipient should perform SR.

12. The method of claim 1, wherein:
the frame comprises a signal (SIG) field that comprises a flag that indicates whether the frame comprises an SR field.

13. The method of claim 12, wherein:
the indication comprises a lack of the SR field; and
the lack of the SR field indicates that the secondary recipient should perform SR using a default SR mode.

14. A method for wireless communications by a first node, comprising:
receiving, from a second node, a portion of a first frame that provides an indication of how to use spatial reuse (SR) information;
determining if a signal strength of the first frame equals or exceeds a threshold; and
if the signal strength of the first frame does not equal or exceed the threshold, transmitting a second frame to a third node during a period when the first frame is being transmitted.

15. The method of claim 14, wherein the second node and an intended recipient of the first frame are members of an overlapping basic service set (OBSS) of the first node.

16. The method of claim 14, wherein the indication is provided via an SR field of a signal (SIG) portion of a preamble of the first frame.

17. The method of claim 14, wherein the SR information is included in the first frame.

18. The method of claim 14, wherein the indication indicates the first node should not perform SR.

19. The method of claim 14, wherein the indication indicates whether the first node should perform SR, based on the SR information, according to a first set of one or more rules or according to a second set of one or more rules.

20. The method of claim 19, wherein the first set includes SR rules when the frame is an 802.11ax frame, and the second set includes SR rules when the frame is a pre-802.11ax frame.

21. The method of claim 14, wherein the indication indicates that the first node should perform SR using a default mode.

22. The method of claim 21, wherein the default mode includes the first node selecting a CCA level and a transmit power for potential spatial reuse over the frame based on a default rule, which is not specified by the frame.

23. The method of claim 21, further comprising:
determining the signal strength of the first frame; and
determining a transmit power level for transmitting the second frame based on the signal strength, wherein transmitting the second frame comprises transmitting the frame at the determined transmit power level.

24. The method of claim 14, wherein:
the first frame comprises an SR field having a clear channel assessment (CCA) level subfield and an interference level subfield;
the method further comprises determining at least one of the CCA level subfield or the interference level subfield includes a reserved value, wherein the indication comprises the reserved.

25. The method of claim 14, wherein:
the first frame comprises an SR field; and
the method further comprises determining the SR field includes a reserved value, wherein the indication comprises the reserved value.

26. The method of claim 14, wherein:
the first frame comprises a signal (SIG) field and has a flag that indicates whether the first frame comprises an SR field.

27. The method of claim 26, wherein:
the indication comprises a lack of the SR field in the first frame; and
the lack of the SR field in the first frame indicates that the first node should perform SR using a default SR mode.

28. The method of claim 14, further comprising:
if the signal strength of the first frame does equal or exceed the threshold, transmitting a second frame to a third node subsequent to the period.

29. An apparatus for wireless communications, comprising:
at least one processor configured to:
generate a frame that provides an indication, to a secondary recipient of the frame, of how to use spatial reuse (SR) information, and
transmit the frame; and
a memory coupled with the at least one processor.

30. An apparatus for wireless communications, comprising:
at least one processor configured to:
receive, from a first node, a portion of a first frame that provides an indication of how to use spatial reuse (SR) information,
determine if a signal strength of the first frame exceeds a threshold, and
if the signal strength of the first frame does not exceed the threshold,
transmit a second frame to a second node during a period when the first frame is being transmitted; and
a memory coupled with the at least one processor.
